(19) United States
(12) Patent Application Publication
(10) Pub. No.: US 2012/0089543 A1
(43) Pub. Date: Apr. 12, 2012

(54) Regulated Data Analysis System

(76) Inventor: Xianghui Wang, Fremont, CA (US)

(21) Appl. No.: 13/272,192

(22) Filed: Oct. 12, 2011

Related U.S. Application Data
(60) Provisional application No. 61/392,035, filed on Oct. 12, 2010.

(51) Int. Cl. G06N 7/00

(52) U.S. Cl. 706/12

(57) ABSTRACT

A data analysis system is invented to analysis business data. The analysis process is regulated to increase accuracy.

### CROSS REFERENCE TO RELATED APPLICTIONS

The present application is related to, and claims priority of, provisional patent application, entitled: “A Regulated Data Analysis System”, with Ser. No. 61/392035, filed on Oct. 12, 2010. The provisional patent application is hereby incorporated by reference in its entirety.

### DESCRIPTION

A data analysis system is invented. In one embodiment of the invention, the system includes a computer (in some embodiments one or more computers, computer clusters, can be used). The computer stores data so that business related analysis can be performed.

For example, in one embodiment, an online store has user profile data including age, gender, location, income range etc. It also has user's history about user past behavior, such as what website it visited, what advertisement it clicked and what product did the user buy. The store might use the user's data to predict user's future behavior (target variable), such as what product the user is likely to buy.

For each user, a row vector (called feature vector) is constructed from user's profile data and behavior data. The elements in the feature vector are in digital format(integers or doubles etc). The elements can be the original data or derived data. For example, one possible vector can be: [age (integer), gender==male (binary, 1 or 0), income (double), located in a big city(binary), time since last bought something (double), looked at some advertisement about TV last month and with estimated income >100K$/year(binary)]

The target variable can be the probability that a user is going to buy a TV.

The feature vector can have many items in some embodiments it might have thousands or millions of items. In general the items are selected so that they might have some relationship with the user behavior that is being estimated. From the historical data that users bought TV or not in the past, an analysis method (will be shown later) is used to estimate a user is going to buy a TV or not in the future.

For another example, in another embodiment, the system is built to estimate the probability that an email is spam. The feature vector can be built from the words used in the email. One can collect a lot of emails and label them either sam or not by inspecting them. All the words used in the email is collected and sorted. The feature vector contains elements that representing the frequencies that each used word used in each individual email. For example, the first element of the feature vector is the frequency of the first word accord in each email. The feature vector elements may also include combination of words. For example: when both ‘free’ and ‘award’ accords in the email. Similarly to the above example, the feature vector elements can be any thing that might be related to the target variable (an email is spam).

For notation, denote the matrix formed by the feature vector x and denote the vector of the target variables y.

In general the analysis problem to be solved is to find a math model as function of a to predict y.

There are many different models can be used for example linear regression, logistic regression etc. However, since there can be many elements in each feature vector, math model might be over-trained during the model training(developing) process. As result, the model can predict the known target variable (for example the historical user behavior) well but cannot predict what happen in real world.

In some embodiments regulations to model parameters can be added to reduce over training problem.

In a preferred embodiment, overall complexity of whole system, including the model, the parameters, and the target variable is used as the regulation metric. The model is selected so that this metric is the minimum. The minimum can be found be solving an optimization problem. In some embodiments, the global optimal solution of the optimization problem may be hard to find. In such cases, local optimal solution (where the regulation metric's derivative equals or close to zero) might be used instead.

The model is denoted as

m(x|a)

where a is a set of parameters used in model m.

The overall complexity of the whole system is denoted as

K(y, x, a)=Z(y|m(x|a))+Q(a)+O(m)

where Z(y|m(x|a)) is the data complexity, i.e. number of bits needed (most time, on average) to describe the data when m(x|a) is known; Q(a) is the coefficient complexity, i.e. the number of bits needed to describe the coefficients; O(m) is the complexity of the model itself, a small constant for most applications.

The optimal model is constructed by solving optimization problem

minₐK(y,x,a)

Data complexity Z(y|m(x|a) can be calculated by log likelihood.

When the target variable is a probability function p (its estimate, i.e. the model's estimate, is \hat{p}(y,x,a)), its log likelihood is denoted as:

L=Σlog(\hat{p}(y,x,a))

and Z(y|m(x|a))=−L

When the target variable is continuous f (its model's estimate is denoted as \hat{f}(y,x,a)), for example in linear regression the log likelihood is denoted as

$$L = {\sum }_{i} log ( \hat{f} ( {y}_{i} , x , a ) )$$

The data complexity Z(y|m(x|a))=−L+a constant.

Hence, for both continuous and discrete variable maximum likelihood methods, the overall complexity becomes

C=−L+Q(a)+O(m)

where Q(a) is the coefficient complexity.

One way to calculate the coefficient complexity, Q(a), is.

$$Q ( a ) \approx {\sum }_{{a}_{i} \neq 0} log ( {n}_{a} ) + 1 + log ( \frac{\vert {a}_{i} \vert}{{ε}_{i}} ) w$$

where nₐ is the number of terms in a. εᵢ is the allowed error, i.e. resolution, of aᵢ.

The vector of allowed errors is denoted as e.

Hence, the overall complexity becomes:

C=−L(y, x, a, e)+Q(a, e)+O(m)

The model can be built by solving optimization problem

$${min}_{a , e} C$$

This problem can be solved using standard optimization techniques.

When e is small there is one efficient way of solving this optimization problem

$$δ {L}_{{ε}_{i}} = {ε}_{i} \frac{\partial L}{\partial {a}_{i}} + {ε}_{i}^{2} \frac{{\partial }^{2} ( L )}{\partial {a}_{i}^{2}}$$

since when L reaches maximum

$$\frac{\partial L}{\partial {a}_{i}} \approx 0$$

denote

$$I ( {a}_{i} ) = - \frac{{\partial }^{2} ( L )}{\partial {a}_{i}^{2}}$$

$$\text{?}$$

$$\text{?} \text{indicates text missing or illegible when filed}$$

as the Fisher's information of aᵢ.

When a is fixed εᵢ's contribution to overall complexity change can is

$$δ {C}_{{a}_{i}} ( {ε}_{i} ) = - {ε}_{i} \frac{\partial L}{\partial {a}_{i}} - {ε}_{i}^{2} \frac{{\partial }^{2} L}{\partial {a}_{i}^{2}} - log ( {ε}_{i} )$$

to minimize it,

we would like to have

$$\frac{d δ {C}_{{a}_{i}}}{d {ε}_{i}} = 0$$

Hence,

$${ε}_{i} = \frac{1}{\sqrt{2 I ( {a}_{i} )}}$$

and

δCₐ_{ᵢ}(εᵢ)=1+½log I(aᵢ)

When εᵢ is known, the overall complexity becomes

$$C = - L + {\sum }_{{a}_{i} \neq 0} log \vert {a}_{i} \vert + log {n}_{a} + 1 + δ {C}_{{a}_{i}}$$

Denote

$${α}_{i} = {n}_{a} * {2}^{1 + δ {C}_{{a}_{i}}}$$

and,

Aᵢ=aᵢaᵢ

Hence,

$$C = - L + {\sum }_{{A}_{i} \neq 0} log ( \vert {A}_{i} \vert )$$

When Aᵢ is small, it is not a good measurement of the coefficient complexity. For example, when Aᵢ<1, the complexity is negative. Hence, we replace log(.) with a smooth function (with continuous value and first derivative) DO:

$$D ( x ) = \{ \begin{matrix}log x & if x \geq e ; \\ x \frac{log e}{e} & if x < e .\end{matrix}$$

Thus a can be found by minimize

$$C = - L + {\sum }_{{A}_{i} \neq 0} D ( \vert {A}_{i} \vert )$$

In general, one efficient to find both a and e is:

1, find a without coefficient complexity

2, find e

3, find new a based on e

4, iterate until converge or meet some exit criteria

1. A data analysis system that consist of: a computer or computer cluster uses data stored in it for business analysis that regulates the complexity of the model to avoid overtraining.

2. a data analysis system as in claim 1, wherein overall complexity is used as the complexity metric

3. a data analysis system as in claim 2, wherein iterative method is used to find the optimal model.
